(19) United States
(12) Patent Application Publication
(10) Pub. No.: US 2017/0096847 A1
(43) Pub. Date: Apr. 6, 2017

(54) ADDITIVE MANUFACTURED MOVEABLE PARTS

(71) Applicant: UCT Additive Manufacturing Center Pte. Ltd., Singapore (SG)

(72) Inventors: Alexander Zhonghong LIU, Singapore (SG); Danqing ZHANG, Singapore (SG); Lit Ping LAM, Singapore (SG); Wei Heng NG, Johor Bahru (MY)

(21) Appl. No.: 14/873,709

(22) Filed: Oct. 2, 2015

(51) Int. Cl. E05D 3/02; G02C 5/22; B33Y 80/00; F16G 15/12; B33Y 10/00

(52) U.S. Cl. CPC E05D 3/02; F16G 15/12; B33Y 10/00; B33Y 80/00; G02C 5/2209; G02C 2200/14

(57) ABSTRACT

A part having at least two portions thereof secured to one another, yet moveable with respect to one another, includes a homogeneous first portion and a homogeneous second portion, wherein a portion of the first portion extends through the second portion, and is secured therein. The part can be configured as a hinge, a chain, etc., wherein the first part includes a pin extending therefrom including a second portion having an enlarged width with respect to the smallest width of a first portion thereof, which is received within a bore in the second portion, wherein the bore includes a second portion having a width greater than the smallest width of a first portion thereof, and the second portion of the pin is received within the second portion of the bore to secure the first part to the second part, but allow movement therebetween. Using additive manufacturing techniques, the first part and second part are formed simultaneously.

### BACKGROUND

Field of the Invention

The present invention relates to the field of additive manufacturing. More particularly, it relates to the field of manufacturing of interlocking moveable parts by adopting additive manufacturing techniques.

Background of the Art

Additive manufacturing, often referred to as 3-D printing, has gained acceptance as a method of manufacturing parts and components for commercial and manufacturing use. Additive manufacturing uses a layer by layer approach to manufacture the part. Based on a computer file of the part layout and dimensions, the part is created directly by forming individual layers of plastic or metal, initially on a support base, and then on the previously deposited layer. Over time, a complete part or component is formed. Often these components are manufactured to near the dimensions of the finished part, and then further machined or otherwise modified to the dimensions of the finished part. In most cases, additional supports are used to form the parts, and these additional supports must be removed to yield the finished part.

Powder bed fusion is one additive manufacturing technique used to manufacture parts. In powder bed fusion manufacturing, the part is analyzed as a series of layers or slices, and a layer of a powder of the material of which the part is to be formed is distributed over a support plate and then a portion thereof is fused using thermal energy such as from a laser in the pattern of a layer or slice of the part to be formed. The part being formed is configured as a plurality of fused layers, stacked and fused together in sequence, typically having a thickness on the order of twenty to 200 microns, each of which comprises a “slice” of the part taken from a CAD or other computer file which is representative of the part. After each slice is fused, another layer of powder is dispensed over the previously fused slice and over the adjacent, unfused powder, and the portion thereof representing the next layer of the part is fused into the shape of the next slice of the part and to the previously fused material. Thus the part is built layer by layer. The metal particles or other fused material is typically distributed over a large area, only some of which is fused. The part is additive manufactured on a platen, which is lowered by the thickness of the powder layer dispensed for fusing after every fusing step, after which the next layer of powder is dispensed on the previously dispensed powder, including the portion thereof previously fused. When the part is completed, the part is removed and the remaining, unfused material powder, is reused to form additional parts.

To date, forming components having interlocking moveable parts of a large size with tight tolerances has not been possible using additive manufacturing techniques. For example, existing techniques limit the size of a part that can be produced, and require tolerance in the range of 0.5 mm to more than 1 mm. This is unacceptable for many applications, and because of the limits on size, designs cannot be scaled. As a result, such moveable parts, such as hinges, are often created by stamping and bending sheet stock into mating parts having interdigited hollow knuckles, into which a hinge pin is inserted to hold the parts together. Alternatively, the mating parts can be cast. In either case, changing the dimensions of the parts is difficult and expensive, as new tooling or molds are required for any change in dimension or configuration.

### SUMMARY

There are provided herein methods and apparatus formed by the methods wherein additive manufacturing techniques such as powder bed fusion are used to simultaneously form a multi piece part, wherein at least one piece of the part can move with respect to another piece of the part. In one aspect, the relative moving parts are connected to one another with the ability to move with respect to each other. In another aspect, a multi piece part having portions thereof moveable with respect to each other is formed without the need for removable supports. In a further aspect, a finished multi piece part having portions thereof moveable with respect to each other which does not require further processing can be formed. The part design is scalable, and high tolerances on the order of 50 um to 100 um can be achieved.

Moveable parts such as hinges and other useful hardware and objects may be formed by the methods described and claimed herein. Additionally, interlinked relatively moveable portions of an elongated member, such as a link chain, may be formed herein, including a linked chain forming a loop on a series of individual interconnected parts.

### DESCRIPTION OF THE DRAWINGS

FIG. 1 is a perspective view of a hinge of the present invention;

FIG. 2 is a sectional view of the hinge of FIG. 1 at 2-2;

FIG. 3 is a plan view of the first layer of the hinge of FIGS. 1 and 2 formed by an additive manufacturing process;

FIG. 4 is a plan view of a further layer formed by an additive manufacturing process over the layer formed in FIG. 3;

FIG. 5 is a plan view of a further layer formed by an additive manufacturing process over the layer formed in FIG. 4;

FIG. 6 is a plan view of a further layer formed by an additive manufacturing process over the layer formed in FIG. 5;

FIG. 7 is a plan view of a further layer formed by an additive manufacturing process over the layer formed in FIG. 6;

FIG. 8 is a plan view of a further layer formed by an additive manufacturing process over the layer formed in FIG. 7;

FIG. 9 is a sectional view of the hinge of FIG. 1 at section 2-2, showing an alternate construct of the hinge pin and hinge bore;

FIG. 10 is a sectional view of the hinge of FIG. 1 at section 2-2, showing an additional alternate construct of the hinge pin and hinge bore;

FIG. 11 is a perspective view of the hinge of FIG. 1 formed integrally with an eyeglass frame;

FIG. 12 is an enlarged view of the eyeglass frame of FIG. 11

FIG. 13 is a side view of a chain formed by an additive manufacturing technique;

FIG. 14 is a plan view of the chain of FIG. 13;

FIG. 15 is a sectional view of one link of the chain of FIGS. 13 and 14; and

FIG. 16 is a side view of one link of the chain of FIGS. 13 and 14.

### DETAILED DESCRIPTION

In the embodiments herein, a device having moveable parts is formed by additive manufacturing. In one aspect, a hinge is described, wherein by simultaneously forming both parts of the hinge using additive manufacturing techniques, a hinge having interlocked yet relative moveable parts is formed. The individual parts of the device interlock, i.e., they cannot be separated from one another. In another embodiment, a chain formed by a plurality of interconnected parts is formed.

The method of manufacturing the device uses an additive manufacturing technique such as powder bed fusion, wherein individual thin layers or slices of different adjacent layers of the parts of the device are sequentially formed, one over the other, to create the device. During the forming of the layers of the different parts or portions of the device, the pattern of the material melted to form each layer or slice includes a space between adjacent parts or portions of the device which are intended to move with respect to each other, and hence portions of two or more different pieces of the device can be simultaneously formed with a clearance gap therebetween, and hence the resulting device will include two or more pieces separated from one another by the gap. As a result, two different yet interlocked pieces may be formed which are moveable with respect to one another. Further, the different parts are constructed such that they cannot be separated from one another intact, i.e., they can only be separated by breaking at least one of the parts. The interlocking parts include angled or curved surfaces angled with respect to the horizontal plane of the printing bed of greater than 30 degrees. Each slice which includes a portion thereof extending outwardly from the underlying slice extends no more than about 1mm, to avoid issues or warping or melting of the overhanging portion as it cools after solidifying. Scalable interlocking parts, having tolerances on the order of 50 um to 100 um, may thus be produced.

As discussed further herein, in an embodiment, a hinge is described wherein the hinge includes a male side with an integral hinge pin formed therewith, and spaced from the mounting plate thereof, and a female part which is formed with an integral knuckle, and the pin is formed in situ within at least a portion of the knuckle. The pin generally has a spool shape, wherein a central cylindrical portion terminates, at opposed ends thereof, in enlarged end portions. In an embodiment described herein, these enlarged portions flare outwardly from a generally central cylindrical portion, but other configurations of the ends, and of the central portion, are specifically contemplated. For example the ends can have a generally arcuate outer surface extending outwardly from a smaller diameter portion thereof in the directions of the opposed ends of the knuckle, which is received in a mating surface in the knuckle of the hinge with a gap therebetween. Additionally, the central cylindrical portion need not be right cylindrical, and can itself be tapered. Alternatively, the central cylindrical portion can be eliminated, such that the pin comprises only opposed enlarged portions extending from, and enlarging in circumference in the extending direction thereof, from a mating location therebetween. Additionally, if the pin extends inwardly of the knuckle from an upper side thereof, only the lowermost part of the pin extending from the central cylindrical portion need be enlarged to enable both relative movement, and interlocking of, the two portions of the hinge.

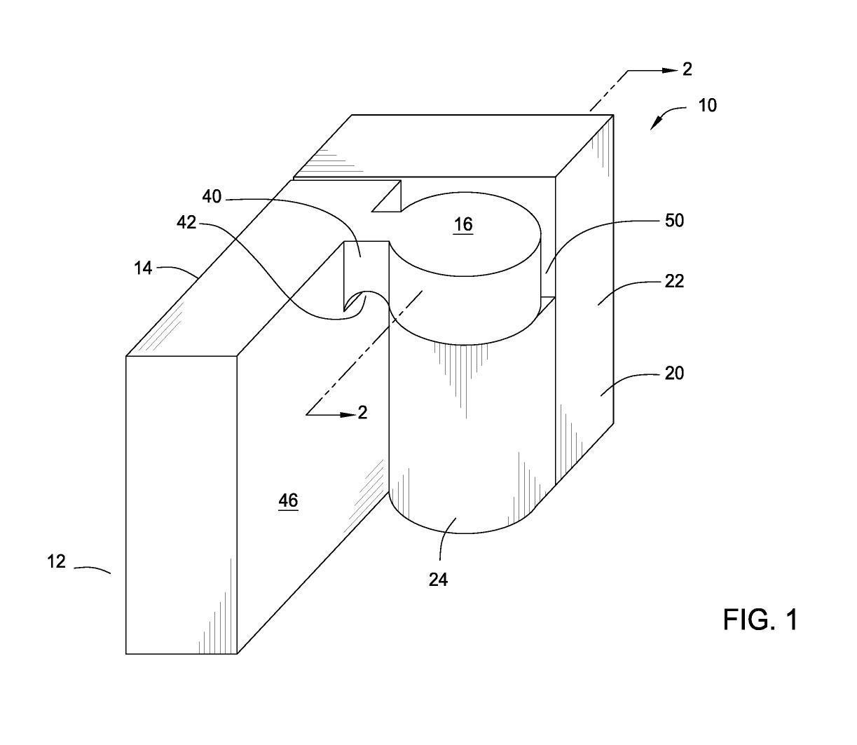

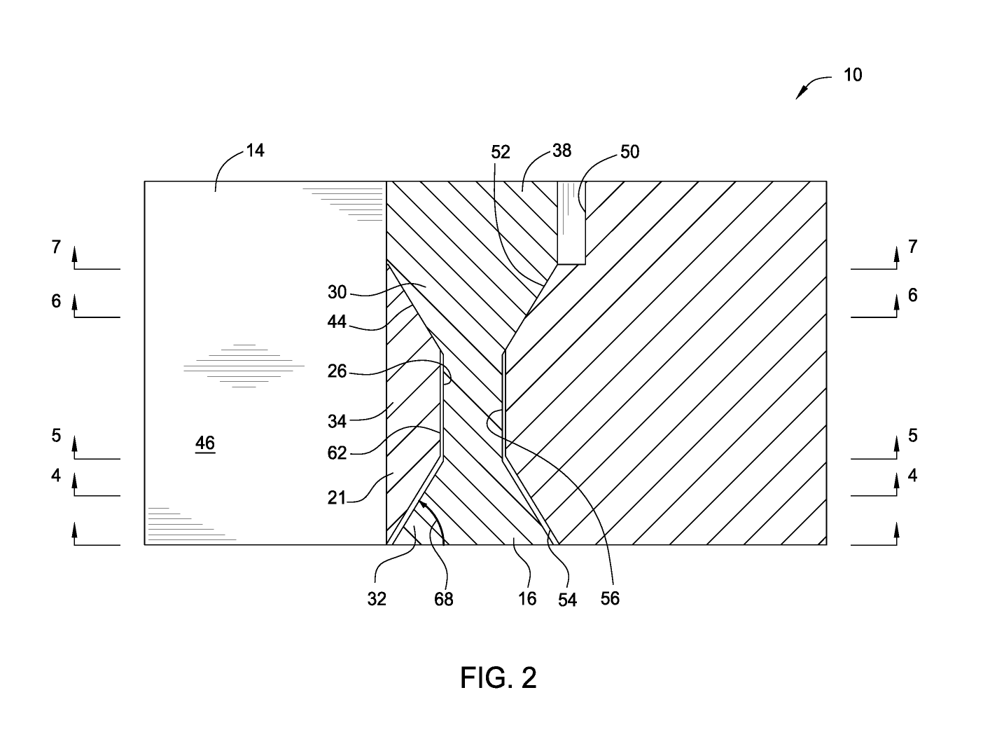

Referring initially to FIG. 1, there is shown a hinge 10 manufactured using the powder bed fusion technique, wherein a male part 12 includes a male side plate 14 and a pin 16 cantilevered therefrom, and a female part 20 includes a female side plate 22 and a knuckle 24, configured to receive the pin 16 therein, extending therefrom. In the embodiment, the pin 16 of the male portion 12 is received in a bore 26 (FIG. 2) of the knuckle 24. The cantilever of the pin 16 from the male side plate 14 provides clearance to allow the male side plate 14 to move without contacting the knuckle 24. By being formed simultaneously using additive manufacturing techniques, the microstructure of each of the male part 12 and female part 20 is homogeneous. As a result, local stresses leading to failures at connection points of the parts 12, 20 of the hinge 10 are eliminated because no connection points are present.

Referring now to FIG. 2, the hinge 10 is shown at section 2-2 of FIG. 1, revealing the interior details of the pin 16, the knuckle 24, and the interconnected construct therebetween forming an interlocked connection therebetween while the pin 16 can rotate within the knuckle 24. In the embodiment, the pin 12 includes an upper conical portion 30, a lower conical portion 32, and a generally right cylindrical connecting portion 34 extending therebetween and forming the structural connection between the upper conical portion 30 and lower conical portion 32. The upper conical portion 30 and lower conical portion 32 are configured as truncated cones, wherein the smaller diameter ends thereof are integrally formed to the opposed ends of the connection portion 34. As shown in FIG. 1, the upper conical portion 30 connects, at the surface thereof distal to the connection portion 34, to an upper cantilever 38, which connects to the male side plate 14 through a bridge 40. Bridge 40 is configured as a spine or elongated plate shaped portion extending from the male side plate 14, having a concave, in the embodiment rounded, lower side 42 formed to blend at one side thereof with the side wall 44 of the cantilever 16, and at the other side thereof with the pin facing wall 46 of the male side plate 14. In the embodiment, the lower side 42 has a radius on the order of less than eight mm, such that where opposed ends of the rounded lower sides blend directly into the pin facing side 44 of the male side plate 14 and the cantilever 16 the space therebetween is on the order of 1 mm or less. However, other radii, and spacings between the pin facing side 44 of the male side plate 14 and the cantilever 16 are possible and specifically contemplated. The spacing and radii are selected based in part upon the size of the interlinked parts being made, the adjacent surfaces, and the size of the gap 62 between the pin 16 and the central bore 26 of the knuckle 24, so that the moving parts do not rub against each other in a location other than between the pin 16 and bore in the knuckle 24, and between the cantilever 38 and upper surface of the knuckle 24, during movement. The radius reduces stress in the bridge, but may be eliminated where unnecessary for structural integrity of the bridge 40.

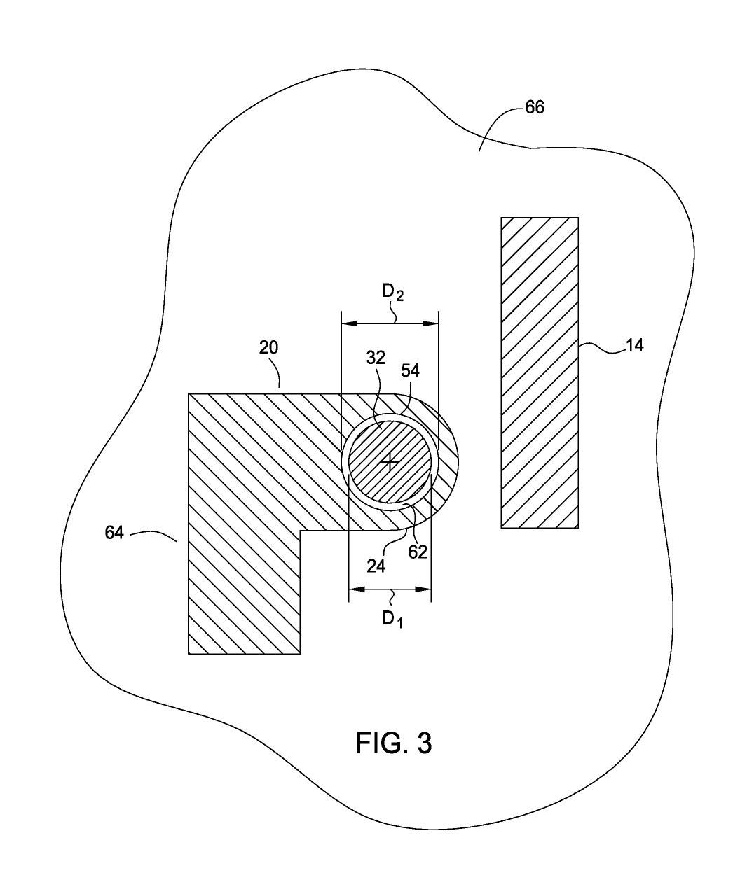

Female part 20 includes female side plate 22 having the knuckle 24 projecting outwardly from a first side 50 thereof. Knuckle 24 includes a central bore 26 comprising an upper frustoconical recess 52 within which the upper conical portion 30 of the pin 16 is received, a lower frustoconical recess 54 within which the lower conical portion 32 of the pin 16 is received, and a generally right cylindrical through opening 56 connecting the upper and the lower frustoconical portion 52, 54, and through which the connection portion 34 of the pin 16 extends. The width, which in this embodiment is the inner diameter of the generally right cylindrical through opening 56 is the same diameter (width) as the smallest diameter (width) of the frustoconical recesses 52, 54, and slightly larger than the outer diameter (width) of the connecting portion 34. Thus, because the upper and lower conical portions 30, 32 have an increasing diameter (width) in the direction thereof extending away from the generally right cylindrical through opening 56, the pin 16 is axially locked against removal from the knuckle 24. However, during manufacture of the hinge 10, as the male part 12 and female part 20 of the hinge are manufactured, a space or gap 62 of unprocessed powder is maintained between the pin 16 and knuckle 24 in each slice of the hinge 10 during the additive manufacturing process, and thus a continuous gap 62 is formed between the upper conical portion 30 and the upper frustoconical portion 52, between the lower conical portion 32 and the lower frustoconical portion 54, and between the generally right cylindrical connecting portion 34 and the generally right cylindrical through opening 56 during manufacture. After manufacture, the powder in the gap 62 is removed, and the male and female parts 12, 20 are free to rotate with respect to each other. The gap 62 has a width greater than zero, and less than that which would allow the pin 16 to be removed from the bore 26 in the knuckle 24. Preferably, the gap 62 is on the order of more than 100 microns, more preferably around 120 microns where the hinge 10 is on the order of one to two cm in height. The angle 68 of the side walls of the frustroconical portions 52, 56, and the conical portions 30, 32, is between 30 and 90 degrees from the plane of the base of the knuckle or the powder bed in which the parts are formed, more preferably between 45 and 90 degrees, wherein there is sufficient overhang between the pin and knuckle that the pin cannot be physically removed from the knuckle intact. After manufacture, when all of the unprocessed material powder is removed, the gap 62 (FIGS. 3 to 8) allows, in addition to relative rotational movement between the male 12 and female 20 portions of the hinge 10, slight axial movement between the pin 16 and the bore 26. Thus, in use, the pin 16 can move slightly downwardly (or upwardly) in the bore 26, such that the conical face of the upper conical portion engages with the frustoconical face of the upper frustoconical portion 52, and a gap 62 remains between the through portion 34 and the through opening 56. Further, the spacing between the lower conical portion 32 and the lower frustoconical portion 54 becomes larger than the gap 62 if the entire pin 16 has moved downwardly in the bore to allow the conical face of the upper conical portion to engage with the frustoconical face of the upper frustoconical portion 52. Alternatively, the pin 16 may be biased upwardly in use such that contact occurs between the lower conical portion 32 and the lower frustoconical portion 54, or the pin 16 may be centered in the knuckle 24 such that the contact occurs between the generally right cylindrical connecting portion 34 and the generally right cylindrical through opening 56. In each case, as a result of providing the gap 62 during manufacturing, interlocked male parts 12 and female parts 20 of a hinge may be simultaneously formed, while the male part 12 and female part 20 remain moveable with respect to each other.

Referring now to FIGS. 3 to 8, the configuration of the hinge 10 is shown during the stages of manufacturing thereof. Each of FIGS. 3 to 8 represent a plan view of the hinge 10 showing the last slice of the hinge 10 to have been formed by an additive manufacturing technique.

Referring first to FIG. 3, a layer of powder 66 of the material comprising the hinge 10 is shown spread over a platen or powder bed (not shown) of an additive manufacturing apparatus, wherein the first slice, i.e., the lowermost slice, of the hinge 10 has been formed in the dispensed powder by powder bed fusion techniques, specifically by laser melting the powder to form the first layer pattern as shown in FIG. 3. The first slice is on the order of 20 to 100 microns thick, the same dimension or slightly less than the thickness of the powder layer 64, and once processed by the laser provides the lowermost portion of the lower conical portion 32, the lower frustoconical portion 54, and the male side and female side plates 14, 22. The lower conical portion 32 and the lower frustoconical portion 54 are formed with the circumferential gap 62 extending therebetween. Additionally, the portion of the male side plate 14 and the pin 16 (lower conical portion 32) are separately formed and spaced from one another, with the formed portion of the lower frustoconical portion 54 of the knuckle 24 disposed therebetween. Powder of the powder layer which has not been laser processed and melted to form the slice remains in place in the gap 62, between the male side 12 and female side 20 portions of the partially formed hinge, and around the partially formed hinge 10. As each slice is formed, by dispensing another powder layer 66 over the previous powder layer(s) and processed (laser sintered or melted) layer(s), the adjacent unprocessed powder provides a physical support for the next powder layer so that portion of the powder not overlying the slice is at approximately the same height as the laser processed portion of the powder formed into the slice. As each powder layer is dispensed over a previously dispensed and processed powder layer, selectivity of the depth of the powder processed into a sintered or melted slice is accomplished by selectively setting the laser energy or focus, and by blanking of the laser except when the beam(s) is directed at the to be processed portion of the powder layer, such that the powder, and the adjacent solidified previously formed slice, are both melted. After the slice is formed, as the melted material cools to re-solidify, atomic level bonding of the adjacent slices occurs. For example. Where the laser can penetrate the powder and underlying previously melted and solidified material to a combined depth of about 100 um, the powder layer is on the order of 50 um thick.

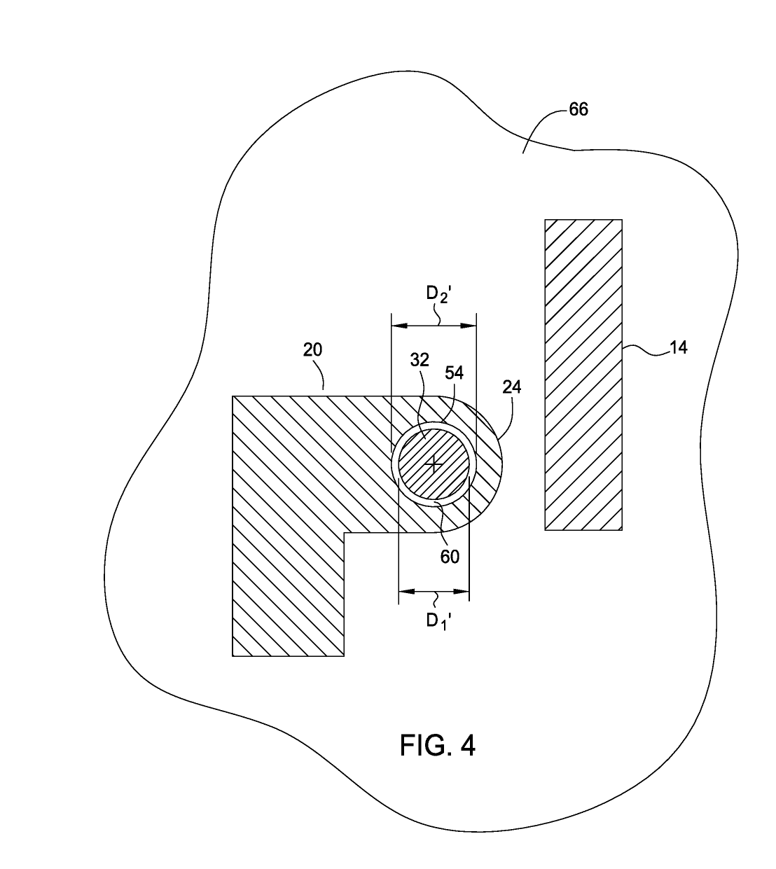

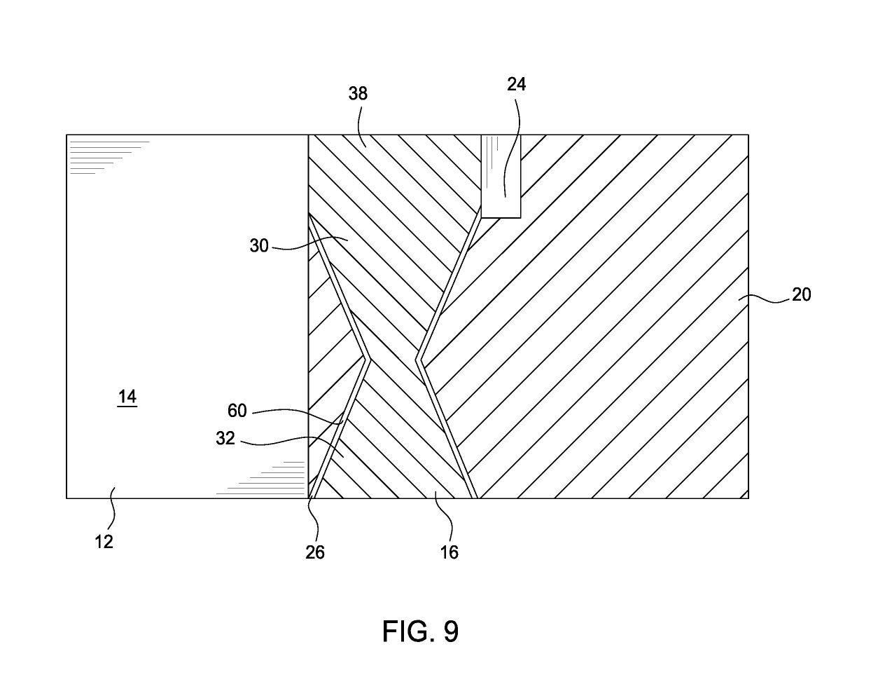

In FIG. 4, the partially formed hinge 10 is shown at level 4-4 of FIG. 2, wherein multiple slices have been sequentially formed over the first slice 62 of FIG. 3 to reach the line 4-4 of FIG. 2. At this point in the manufacture of the hinge 10, the diameter of the lower conical portion 32 has decreased in comparison the its diameter in the first slice of FIG. 3 as its height (or thickness) has increased, and the inner diameter of the lower frustoconical portion 54, spaced from and surrounding the lower conical portion 32, has likewise decreased in comparison to its diameter in FIG. 3 as its height (or thickness) has increased, and the gap 62 remains circumferentially therebetween. Likewise unprocessed powder remains in place in the gap 62, between the male side 12 and female side 20 portions of the partially formed hinge 10, and around the partially formed hinge 10. The gap 62 is sized such that the laser, when penetrating the powder of the slice being processed, does not span the depth D of the gap 62 as shown in FIG. 9.

Because the powder layer adjacent to the previously formed stack of slices of the hinge has the same height, or substantially the same height, as the previously formed stack of slices, a fresh layer of powder 66 extends across the gap 62, and between the male side plate 14 and female side plate 22 of the partially formed hinge. The laser scans and melts the desired cross sectional area of a particular slice according to the computer generated file for the slice. As a result, in a particular layer, two or more portions of a device can be formed simultaneously. Areas where the laser did not scan will remain unmelted as loose powders. Thus, the gap 62 now extends downward and radially outwardly from the location thereof in FIG. 4 to the location thereof of FIG. 3, (from level 4 to level 3 in FIG. 2) and thus two sintered or melted and reformed portions of the hinge 10 are constructed such that they are physically spaced from each other, and one portion thereof (the lower frustroconical portion 54) extends over, and is spaced from another portion thereof (Lower conical portion 32). Thus, the diameter D1 of the lower conical portion and the inner diameter D2 of the lower frustoconical portion 54 of the initial slice of FIG. 3 is greater than the diameter D1′ of the lower conical portion and the inner diameter D2′ of the lower frustoconical portion 54 of FIG. 4 after multiple slices have been formed.

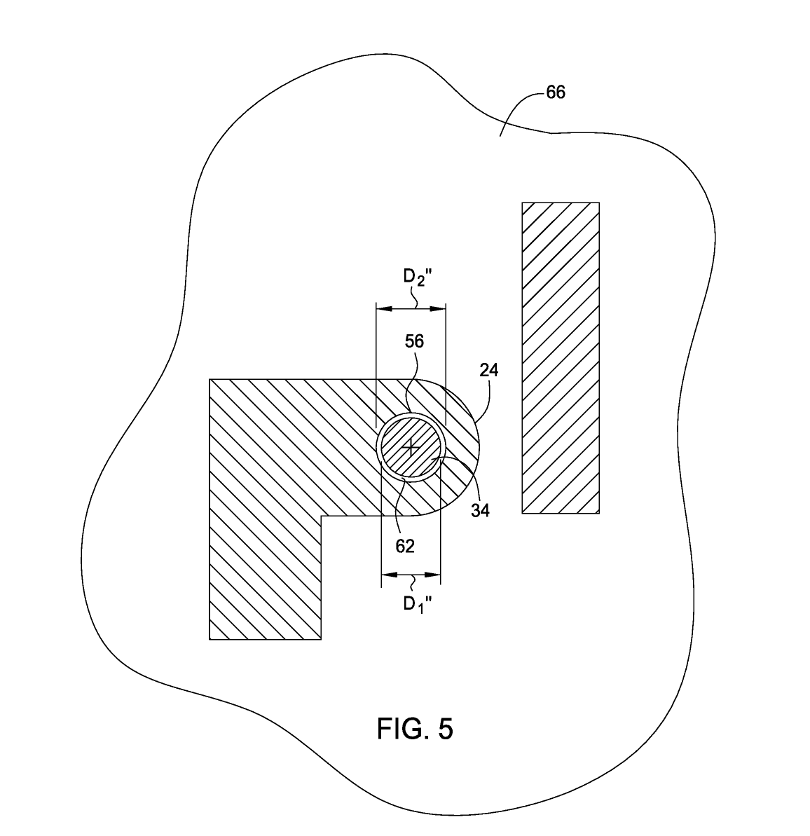

Referring now to FIG. 5, which is a plan view of FIG. 2 at level 5-5, the partially formed hinge has been formed up to the connection portion 34 of the pin 16 and the generally right cylindrical through opening 56 by laser processing additional powder layers. At this point, the circumferential gap 62 extends outwardly and, in the reference of the drawing, down from the location thereof in FIG. 5 to the location thereof in FIG. 3, and the diameter D1″ of the first and second connecting material is smaller than the diameter D1′ of the lower conical portion 32 and the inner diameter D2″ of the generally right cylindrical opening 56 is smaller than the diameter D2″ of the lower frustoconical portion 54.

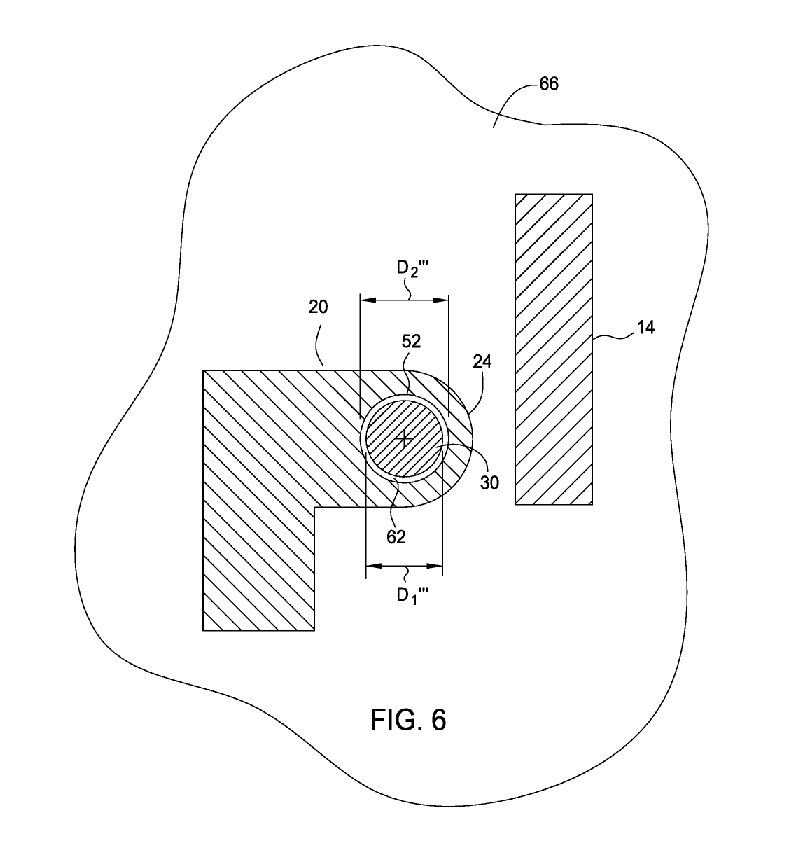

Referring now to FIG. 6, the hinge 10 has been formed up to approximately the mid-section of the upper conical portion 30 at level 6-6 of FIG. 2. As the hinge 10 continues to be formed above the connection portion 34 of the pin 16, the diameter D1″′ is increased in comparison to the diameter D1′ of the connection portion 34, as does the inner diameter D2″′ of the bore of the upper frustoconical portion 52 as compared to the inner diameter D2″ of the generally right cylindrical opening 56, so that the upper conical portion 30 starts to extend over the upper frustoconical portion 52, and the gap 62, filled with unprocessed powder 66, between the partially formed male part 12 and female part 22 remains filled with powder. Again, the gap 62 is sized such that the laser, when penetrating the powder of the slice being processed, does not span the depth direction D of the gap 62.

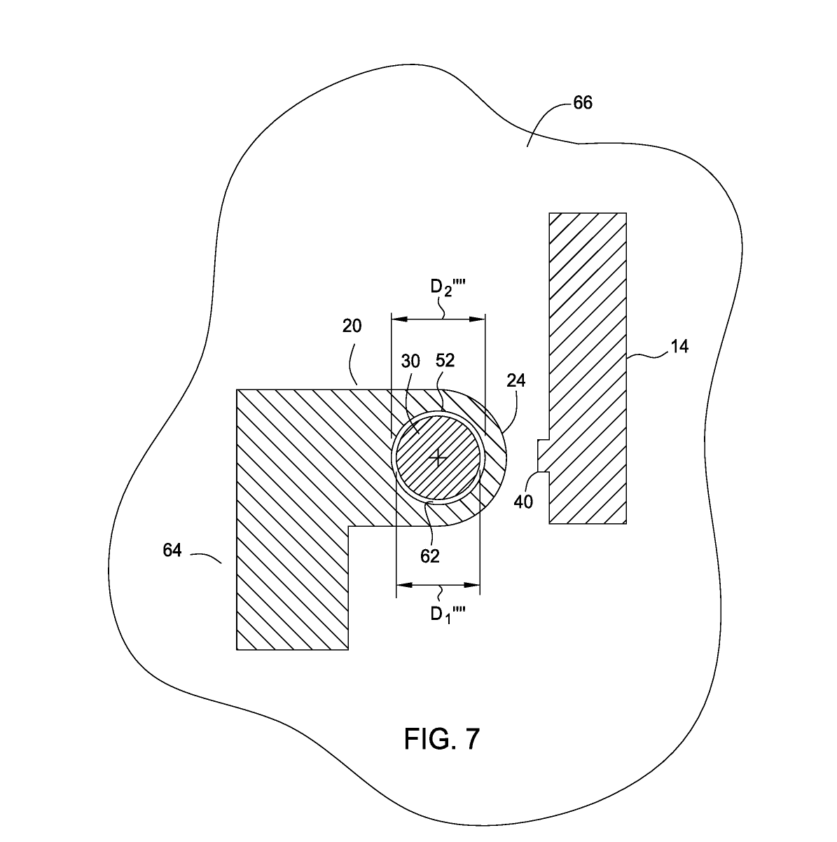

In FIG. 7, the partially formed hinge has been formed up to the top of the knuckle 24 of the female part 20, i.e., the largest diameter portion of the upper frustoconical portion. Here, the diameter D1″″ of the upper conical portion 30 is approximately equal to the diameter D1 of the lower conical portion 32 at the initial slice of FIG. 3, and the inner diameter D2″ of the upper frustoconical portion 52 is approximately that same as that of the diameter D2 of the lower conical portion 54 of the first slice. Thus, the pin 16 is formed with the generally right cylindrical connecting portion 34 in the middle thereof, and the upper conical portion 30 and lower conical portion 32 extending from either end thereof, their diameters increasing as the distance thereof from the generally right cylindrical connecting portion 34 increases. Likewise a mating bore in the knuckle 24 is formed, extending from the lower end of the thereof, through the lower frustroconical portion 54, the generally right cylindrical through opening 56 and the upper frustoconical portion 52. The pin 16 is positioned in the knuckle 24, with the gap 60 extending therebetween. Additionally, the beginning of the bridge 40 is shown extending from male side plate 14 in the direction of knuckle 24.

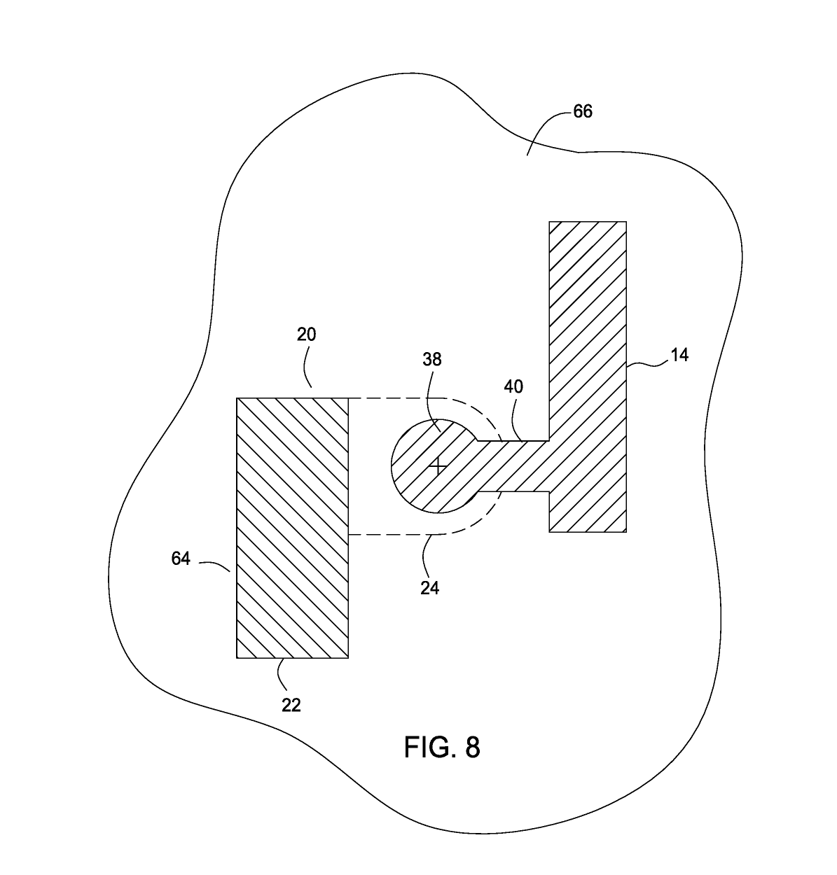

Referring now to FIG. 8, further slices of the hinge have been formed, such that unprocessed powder 66 overlies the knuckle 24 (shown in phantom) of the female side part 20, and the bridge 40 is partially formed and extends from male side plate 14 to the upper cantilever 38 formed over the upper conical portion 30 of pin 16. Additional slices are laser processed to form the final hinge 10. The final height of the hinge 10 is determined considering the cross sectional area and height of the bridge 40 required to ensure reliability of the hinge 10 in use.

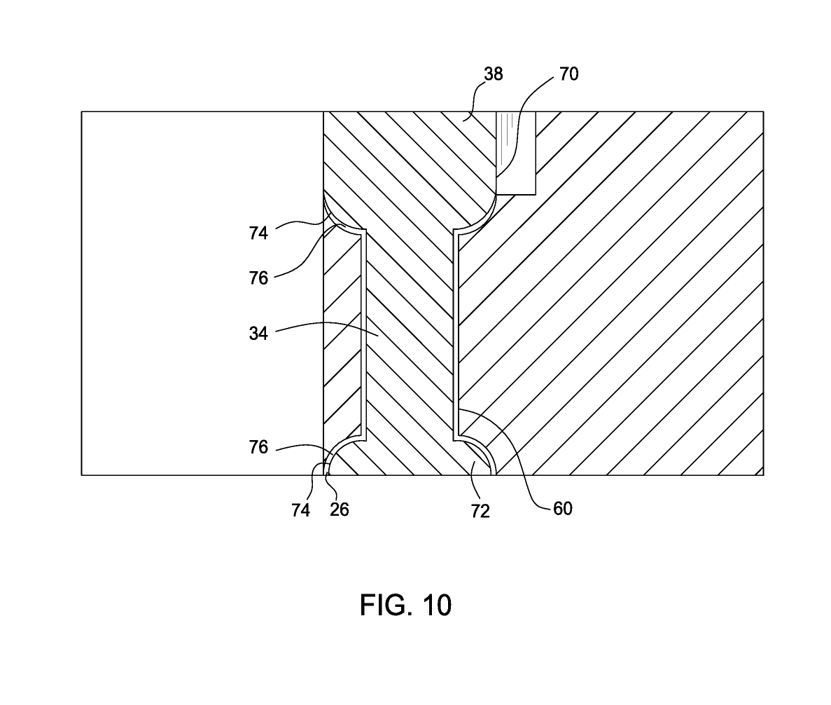

Referring now to FIGS. 9 and 10, alternative constructs of the profile of the pin 14 and knuckle 24 are shown in section. In FIG. 9, pin 16 has a modified construct in which connecting portion 34 has been eliminated, and upper conical portion 30 and lower conical portion 32 connect approximately midway, in the depth direction, of the knuckle 24. Again, gap 60 remains between the pin 16 and knuckle 24. Pin 16 is restrained against axial movement, as movement of the pin 16 upwardly will cause lower conical portion 32 to engage against lower frustoconical portion 54, and downward movement of the pin 16 in knuckle 24 causes upper conical portion 30 to engage against upper frustoconical portion 52, but the pin 16 is free to rotate in the knuckle 24.

In FIG. 10, pin 16 and the central opening 26 through the knuckle 24 have radiused surfaces. Thus, pin 16 includes the connecting portion 34, at one end of which is an upper radially extending portion 70 and at the other end of which is a lower radially extending portion 72. Each radially extending portion 70, 72, includes a curved outer surface 74 curving inwardly from the lower end of the pin and from the base of the cantilever 38. Knuckle includes the central opening 56, and at opposed ends thereof inwardly curved recesses 76. Again, during additive manufacturing, a continuous gap 60 is maintained between the outer surfaces of the pin 16 and the inner bore surfaces of the knuckle 24. Because the upper and lower radially extending portions 70 and 72 are larger in diameter than the central opening 56, pin 16 is restrained in the axial direction, but free to rotate in the knuckle 24.

In FIG. 10A, pin 16 and the central opening 26 through the knuckle 24 have continuous arced or radiused surfaces. Thus, the connecting portion 34 of the pin 16 may be eliminated, and an outwardly extending upper portion 70a extends inwardly of the upper end of the central opening 56, and an outwardly extending lower portion 70b extends from the lowermost extent of the upper portion 70 to the lower opening of the central opening. Thus, the pin has a smaller diameter between the opposed openings of the central opening 56, and enlarges in the upward and down ward directions, i.e., in opposed directions from the small diameter portion of the pin 16. As a result, a continuous concave outer wall 70b is formed on the exterior of the pin 16. Knuckle 24 includes the central opening 26, and at opposed ends thereof convex curved recesses 76a which together form a continuous convex wall 76c. Again, during additive manufacturing, a continuous gap 62 is maintained between the outer surfaces of the pin 16 and the central opening 56 surfaces of the knuckle 24. Because the upper and lower radially extending portions 70 and 70 are larger in diameter than the central opening 56, pin is restrained in the axial direction, but free to rotate in the knuckle 24.

Additionally, in each embodiment hereof, the upper conical portion 30 or the radial extending portion 70 may be eliminated, such that the pin 16 comprises the connecting portion 36 and the lower conical portion, and the bore includes only the through bore 56 and the lower frustoconical portion 54, or the pin includes only the connecting portion 34 and the lower radially extending portion, and the bore 26 includes only the through bore 56 and the lower curved recess 76.

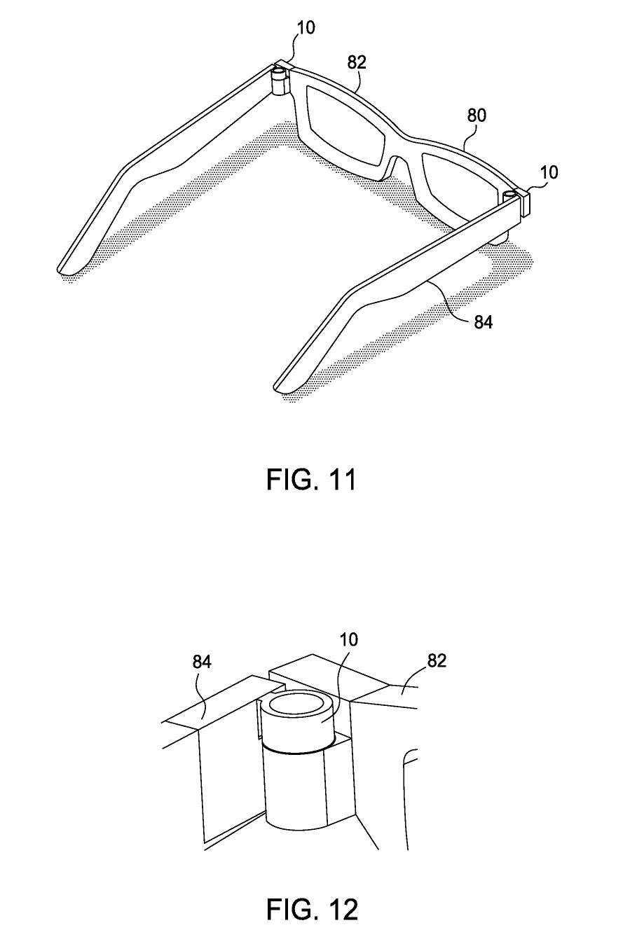

Referring now to FIGS. 11 and 12, an example of the hinge 10 of FIGS. 1 and 2 manufactured into a consumer product, here specifically an eyeglass frame 80, is shown. In the embodiment shown, the entire eyeglass frame may be manufactured by additive manufacturing techniques, and thus the first layer of the hinge 10 as shown in FIG. 3 will not be formed directly on the base of a 3-D printer, but on one or more layers of unprocessed powder adjacent to processed powder regions forming portions of the lens holders 82 and ear pieces 84 of the eyeglass frame 80. Thus, a single eyeglass frame 80 having integrally formed hinges 10 may be easily formed. Alternatively, one of the male side part 14 or the female side part 22 of hinges 10 may be otherwise affixed to opposed sides of the lens holders 82, and the other affixed to the earpieces 84.

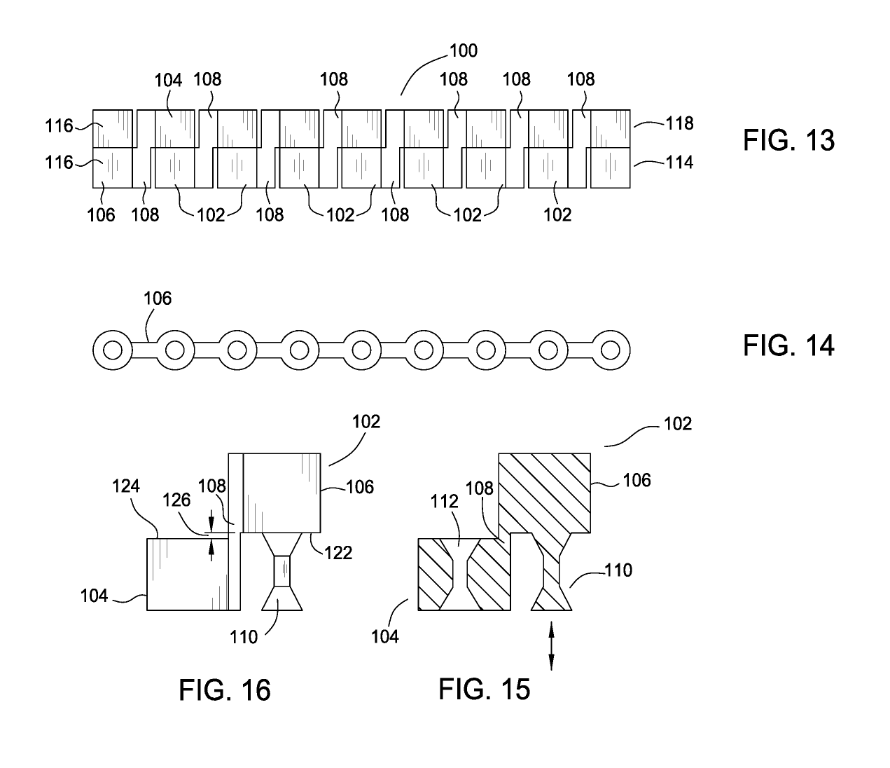

The process used to configure the hinge 10 of FIGS. 1 and 2 can also be used to configure additional parts or products, for example a chain 100 as shown in FIGS. 13 to 16. As shown in FIGS. 13 and 14, chain 100 is configured from a plurality of interconnected links 102, each of which includes an upper knuckle portion 104, and a lower cantilever portion 106 interconnected by a bridge 108, and a configured pin 110 extending upwardly from the lower cantilever portion 108 (FIGS. 15 and 16). During the additive manufacturing process, a space comprising unmelted powder is maintained between the top of the knuckle portion 104 and the underside of the cantilever portion 106 of the adjacent link, to create the physical separation thereof. Any number of such interconnected links 102 can be simultaneously formed in the same manner as hinge 10 of FIGS. 1 and 2, such that a continuous chain of interconnected links 102 which are restrained in the axial 112 direction of the pin 110 but are free to rotate with respect to each other. As with the hinge 10 embodiment, any number of materials, such as stainless steel, aluminum and nickel can be used to form the chain 100, and any metal powder or a metal powder compound which can be laser melted and re-solidified is used to form the chain 100. The material of the finished chain 10 is thus limited only by the availability of a powder having the finished material composition therein.

As shown in FIGS. 13 and 14, the chain 100 terminates in links 114, 116 which are configured as incomplete versions of links 102. Thus, link 116 includes only the knuckle portion 104. Link 114 includes only the cantilever portion 108 and the configured pin 110 of FIGS. 15 and 16. Alternatively, links 112, 114 may be configured the same as links 102, or, a continuous chain, wherein the first link 116 is interconnected to the last link 118 may be formed. A continuous chain 100 can thus form jewelry such as a bracelet, a neck chain, etc. Alternatively, the opposed ends of the chain may be configured to mate with a clasp, or an integral clasp structure may be formed of mating parts on the on the first and last links 116, 118

Referring now to FIGS. 15 and 16, details of each link 102 of the chain 100 are shown in the orientation of manufacture, i.e., the lower part of the drawing corresponds with the bottom of the link during the additive manufacturing process. As described above, each link 102 includes a knuckle portion 104, and a cantilever portion 106 interconnected by a bridge 108, and a configured pin 110 extending downwardly from the underside of the cantilever portion 108. As shown in section in FIG. 15, the entire link 102 is formed as one continuous, i.e., homogeneous piece without seams or connecting parts. During manufacture, all of the links 102 of the chain 100 are formed simultaneously, with the configured pin 110 of a first link formed in the knuckle bore 112 in the knuckle portion 104 of an adjacent link, and so on. Knuckle bore 112 has the same construct as the central bore 26 in the knuckle 24 of the hinge 10 of FIG. 3. Bridge 108, in contrast to the bridge of the embodiment of FIG. 3, extends downwardly from its connection with the knuckle portion 102 at the side thereof, to engage the side of the cantilever 108 which is above, and laterally offset from, the knuckle portion 102. Thus, during manufacture of the interconnected links wherein multiple links are formed simultaneously in the interlocked configuration shown in FIGS. 13 and 14, the inner diameter of the knuckle bore 112 at each slice is larger than the outer diameter of the configured pin at the same slice, and thus the continuous gap 62 of FIG. 2 is formed. Thus, a chain having links locked to each other, but moveable rotationally with respect to one another, is formed. Space 120 is provided by setting the plane of the lower surface 122 of the cantilever higher than the upper surface of the pin portion 104 by a space amount 126.

As described herein, two interlocking, homogenous pieces can be formed wherein the interlocked pieces can also move with respect to each other. Although specific configurations of the parts, in particular the knuckle 24, knuckle bore 26 and the pin 14 have been described, variants thereof within the scope of the disclosure are specifically contemplated herein.

What is claimed is:

1. A part having a first portion and a second portion, comprising:
a first portion secured within the second portion against removal from the second portion;
the first portion and second portion rotatable with respect to one another;
a portion of the second portion overlying the first portion, wherein the portion of the second portion overlying the first portion extends at an angle of between 30 and 90 degrees from a plane of the base of the part; and
each of the first portion and second portion are homogeneous.

2. The part of claim 1, wherein the first portion comprises a pin having a first pin portion and a second pin portion extending from the first pin portion, and the width of at least one portion of the second pin portion is greater than the smallest width of the first pin portion.

3. The part of claim 2, wherein the second portion includes a through bore extending therethrough, the through bore comprising a first bore portion and a second bore portion, and the second bore portion has at least one portion thereof having a greater width than the smallest width of the first bore portion; and
the first pin portion is located within the first bore portion, and the second pin portion is received within the second bore portion.

4. The part of claim 3, wherein a continuous gap is located between the second pin portion and the second bore portion, and the first pin portion contacts the surface of the first bore portion.

5. The part of claim 4, wherein the first portion further comprises a hinge plate connected to the first pin portion, and the second portion further comprises a knuckle having the through bore extending therethrough and a hinge plate connected to the knuckle.

6. The part of claim 3, further comprising a third pin portion extending between the first pin portion and the second pin portion, and a third bore portion extending between the first bore portion and the second bore portion, and the third pin portion extends through the third bore portion.

7. The part of claim 6, wherein a continuous gap is located between the second pin portion and the second bore portion, and between the third pin potion and the third bore portion, and the first pin portion contacts the surface of the first bore portion.

8. The part of claim 3, wherein the gap is lass then 100 μm.

9. A chain, comprising:
a plurality of interconnected links, wherein each link is homogenous.

10. The chain of claim 9, wherein each link comprises a female portion having a bore extending therethrough, a male portion having a pin extending therefrom, and a connecting portion extending between the male portion and the second portion, and spacing the male portion from the female portion.

11. The chain of claim 9, wherein the bore comprises:
first bore portion and a second bore portion, wherein the width of at least a portion of the second bore portion is greater than the smallest width of the first bore portion.

12. The chain of claim 10, wherein the pin comprises a first pin portion and a second pin portion, wherein the width of at least a portion of the second pin portion is greater than the smallest width of the first bore portion.

13. The chain of claim 11, further comprising;
a third bore portion connecting the first pore portion and the second bore portion; and
a third pin portion extending between and connecting the first pin portion and the second pin portion, and the third pin portion is received within the third bore portion.

14. The chain of claim 13, further comprising a continuous gap extending between the second pin portion and the second bore portion.

15. The chain of claim 14, wherein the second bore portion comprises a frustoconical surface, the second pin portion comprises a conical portion having a conical surface extending from the third pin portion to an opposed base of the pin, and the angle formed between the base of the pin and the conical surface is between 30 and 90 degrees.

16. A method of forming a part having at least an interlocked homogenous first portion and homogeneous second portion rotatable with respect to each other, wherein the first portion includes a pin comprising a second pin portion having a greater width than the smallest width of a first pin portion thereof, and the pin is received in a bore having a second bore portion having a greater width than the smallest width of a first bore portion thereof; comprising:
simultaneously forming a first plurality of layers of the second pin portion and the second bore portion, with a gap therebetween, one layer over the next layer and affixing each layer to the previously formed layer using layers of a particulate material and a focused laser; and then
simultaneously forming a second plurality of layers of the first pin portion and the first bore portion, with a gap therebetween using layers of a particulate material and a focused laser, with the first layer of the plurality of layers formed on the last layer of the first plurality of layers and affixed thereto, one layer over the next layer and affixing each layer to the previously formed layer, wherein;
during the forming of the first plurality of layers, the width of the second pin portion and second bore portions decrease as successive layers are formed, and during the formation of the second plurality of layers the width of the first pin portion and the first bore portion increases as the successive layers of the second plurality of layers are formed; and
the depth of the gap in the direction of incidence of the laser is greater than the penetration depth of the focused portion of the laser into the powder.

17. The method of claim 16, further comprising forming the gap between the first pin portion and the first bore portion, and between the second pin portion and the second bore portion, as a continuous gap.

18. The method according to claim 16, wherein the second pin portion comprises a conical surface, and the second bore portion comprises a frustoconical surface facing the conical surface of the second pin portion.

19. The method of claim 16, further comprising a third bore portion connecting the first and second bore portions; and
a third pin portion connecting the first pin portion and the second pin portion, the third pin portion extending through the third bore portion with a gap extending therebetween.

20. The method of claim 17, further comprising during the forming of the first and second pluralities of layers, forming a portion of a first portion hinge plate and a second portion hinge plate.

21. The method of claim 20, further comprising forming a third plurality of layers after forming the first and second plurality of layers, wherein the third plurality of layers simultaneously form a further portion of the first hinge plate and the second hinge plate, a cantilever overlying the first pin portion, and a bridge connecting the cantilever and the first hinge plate, the bridge spacing the cantilever from the first hinge plate.
